(19) United States
(12) Patent Application Publication
(10) Pub. No.: US 2007/0092853 A1
(43) Pub. Date: Apr. 26, 2007

(54) Multi-layer casting methods and devices

(76) Inventors: Frank Zhenhuan Liu, Belmont, CA (US); Gang Liu, Montreal (CA); Wenjia Liang, Xi'an (CN); Wahab Waqas, Lahore (PK); Huafeng Wen, Redwood City, CA (US)

Correspondence Address: FRANK Z. LIU, 270 CLUB DRIVE, BELMONT, CA, 94070, US

(21) Appl. No.: 11/258,465

(22) Filed: Oct. 24, 2005

(51) Int. Cl. A61C 11/00

(52) U.S. Cl. 433/213

(57) ABSTRACT

Described herein are methods for making highly accurate layered dental models from a cast of a subject's oral cavity (e.g., the upper or lower dental arch) that avoid shrinkage or deformation. The methods may include the steps of sequentially preparing the model-forming material, applying a layer of model-forming material to a cast, and curing the layer before applying the next layer. The model-forming material may include one or more stabilizers (e.g. thermal stabilizers). Dental models having multiple layers are also described.

### CROSS-REFERENCES TO RELATED INVENTIONS

The present invention is related to the following U.S. Patent Applications: U.S. patent application Ser. No. 11/107,584, titled “Digital aligner devices having snap-on features” by Huafeng Wen et al, filed Apr. 15, 2005, U.S. patent application Ser. No. 11/074,301, titled “Dental aligner for providing accurate dental treatment” by Liu et al, filed Mar. 7, 2005, U.S. patent application Ser. No. 11/074,297, titled “Producing wrinkled dental aligner for dental treatment” by Liu et al, filed Mar. 7, 2005, U.S. patent application Ser. No. 11/074,300, titled “Fluid permeable dental aligner” by Huafeng Wen, filed Mar. 7, 2005, U.S. patent application Ser. No. 11/074,298, titled “Disposable dental aligner by Huafeng Wen, filed Mar. 7, 2005, U.S. patent application Ser. No. 11/050,051, titled “Storage system for dental devices” by Huafeng Wen, filed Feb. 3, 2005, U.S. patent application Ser. No. 10/979,823, titled “Method and apparatus for manufacturing and constructing a physical dental arch model” by Huafeng Wen, filed Nov. 2, 2004, U.S. patent application Ser. No. 10/979,497, titled “Method and apparatus for manufacturing and constructing a dental aligner” by Huafeng Wen, filed Nov. 2, 2004, U.S. patent application Ser. No. 10/979,504, titled “Producing an adjustable physical dental arch model” by Huafeng Wen, filed Nov. 2, 2004, U.S. patent application Ser. No. 10/979,824, titled “Producing a base for physical dental arch model” by Huafeng Wen, filed Nov. 2, 2004, U.S. patent application Ser. No. 11/013,152, titled “A base for physical dental arch model” by Huafeng Wen, filed Dec. 14, 2004, U.S. patent application Ser. No. 11/012,924, titled “Accurately producing a base for physical dental arch model” by Huafeng Wen, filed Dec. 14, 2004, U.S. patent application Ser. No. 11/013,145, titled “Fabricating a base compatible with physical dental tooth models” by Huafeng Wen, filed Dec. 14, 2004, U.S. patent application Ser. No. 11/013,156, titled “Producing non-interfering tooth models on a base” by Huafeng Wen, filed Dec. 14, 2004, U.S. patent application Ser. No. 11/013,160, titled “System and methods for casting physical tooth model” by Huafeng Wen, filed Dec. 14, 2004, U.S. patent application Ser. No. 11/013,159, titled “Producing a base for accurately receiving dental tooth models” by Huafeng Wen, filed Dec. 14, 2004, and U.S. patent application Ser. No. 11/013,157, titled “Producing accurate base for dental arch model” by Huafeng Wen, filed Dec. 14, 2004. The disclosure of these related applications are herein incorporated herein by reference in their entirety.

### TECHNICAL FIELD

This application generally relates to the field of dental care, and more particularly to the field of orthodontics.

### BACKGROUND

Many dental and orthodontic procedures benefit from the use of an accurate model of a subject's teeth that can be observed and manipulated. Such models may be negative models (e.g., casts) or positive models. In particular, accurate and durable models may be used by a practitioner (e.g., an orthodontist, doctor, oral surgeon, etc.) to guide the treatment or diagnosis of a subject. For example, a model may be used as a template to create dental implants. An orthodontist may also use a model to create a treatment plan for realigning teeth, or for fitting dental devices (e.g., braces, brackets, bands, retainers, aligners, etc.). As the subject's teeth are moved, the dental model may be adjusted to reflect the movement. In some cases, the model may be manipulated to project or to illustrate a treatment outcome.

For example, U.S. Pat. No. 5,518,397 to Andreiko, et. al. describes a method of forming an orthodontic brace using a model. The method includes obtaining a model of a subject's teeth and a prescription of desired positioning of the teeth. The contour of the subject's teeth is determined from the model. Calculations of the contour and the desired positioning of the subject's teeth are made and custom brackets are then created for receiving an arch wire to form an orthodontic brace system. The device of U.S. Pat. No. 5,518,397 places an arched wire on the bracket in a progressive curvature in a horizontal plane and a substantially linear configuration in a vertical plane. The brackets are customized to provide three-dimensional movement of the teeth.

Dental models may be made by taking an impression from the mouth, or they may be made by measuring, scanning and/or imaging techniques. For examples of scanning techniques, see U.S. Pat. Nos. 5,605,459; 5,533,895; 5,474,448; 5,454,717; 5,447,432; 5,431,562; 5,395,238; 5,368,478; and 5,139,419. All of the patents and references referred to in this specification (including U.S. Pat. No. 5,518,397 to Andreiko, et. al) are incorporated by reference in their entirety where there are cited. Realistic dental models may be used once or may be re-used in order to help design dental treatments.

For example, realistic simulations of teeth position are extremely helpful to many orthodontic treatment processes. Orthodontists may use plaster models of the upper and lower arch to create a set-up that may be manipulated to model the starting and finishing positions of teeth, and help eliminate guesswork. Dental appliances (such as brackets) may be attached to the dental model. However, traditional dental models may be too fragile or easily damaged, or may not be capable of being reused.

Dental models may also be used to help design and fabricate dental aligners, for helping realign a subject's teeth. For example, a removable aligning device may be used to realign a subject's teeth, and may be fabricated using a dental model. Thus, an orthodontist can obtain an impression model of a subject's dentition (e.g., a negative model) that can be used to form a positive model onto which appliances can be fabricated. A practitioner (e.g., an orthodontist) can manipulate the positive model (or similar models) to make any changes he or she wishes to make to individual tooth positions. A series of removable aligning devices (aligners or shells) can then be manufactured and provided to the subject so that the subject can wear the aligners. The shells, in theory, will move the subject's teeth to a desired or target position.

Thus, a model of the subject's teeth can help guide the desired movement of the subject's teeth during an orthodontic treatment. The model can help avoid interference between a subject's teeth when undergoing dental re-alignment. A model can also provide input for the design and manufacturing of dental aligner devices. Because a dental model can be used to design dental implants, aligners, and treatments, it is important that the dental models be highly accurate. The more accurate the dental model, the more accurate and potentially more effective the dental treatment or device may be.

Unfortunately, most dental models do not conform to highly stringent design tolerances. For example, many physical dental models are not accurate to within one percent error from either the original dental imprint or the subject's actual dentation. For example, reusable dental models made from polymeric materials (e.g., epoxies) may shrink or deform slightly during creation of the model, and models made from other settable materials (e.g., plasters, etc.) may also shrink as they set up (e.g., losing moisture as they harden). Further, any known models are made of materials that are too fragile or brittle.

The methods and devices described herein may address some of the challenges identified above.

### SUMMARY OF THE INVENTION

The present invention provides systems and methods to manufacture and organize aligners. Implementations of the system may include one or more of the following.

Described herein are methods of making a layered dental model. The method may include the steps of applying a first layer of model-forming material to a cast, curing the first layer of model-forming material, applying a second layer of model-forming material and curing the second layer of model forming material. Many more layers may also be included, and each layer may be cured before applying the next layer. Thus, a third layer of model-forming material can be applied, and cured, a fourth layer, etc. The method may also include a step for removing the dental model from the cast.

The model-forming material can be referred to as casting material, and may be any appropriate material, including but not limited to plaster, polymeric materials (including plastics, polyurethanes, etc.), ceramic materials, metals, alloys, or combinations thereof). For example, the model-forming material may be a plaster or cement. In some variations, the model-forming material is polyurethane or Epoxy. In case of Epoxy, the Epoxy may comprise two or more components that are mixed before using them (e.g., a resin and a hardener). Thus, the method may include a step of mixing the resin and the hardener to prepare the model-forming material.

The step of applying the first layer of model-forming material may include brushing the model forming material against the cast. Brushing may form a thin coating layer. The model-forming material may be applied by any appropriate technique. As mentioned, the model-forming layer may be brushed on (e.g., with a brush or other applicator). The model forming material may also be sprayed on (e.g., with a sprayer, nozzle, etc.), or poured. In some variations, the layer may be applied by a combination of application techniques.

A first layer may be applied around a support or framework (e.g., skeleton) about which additional layers are added. For example, a support may be placed into the cast and additional layers of materials may be applied around it. In some variations, a support is formed by first applying a high-shrinkage material into at least a part of the cast, and allowed to shrink. Additional layers may be applied to correct the shape as described herein.

The model forming material forming each layer may be cured in any appropriate manner. Curing typically involves hardening of the model-forming material from a pourable solution (e.g., a liquid, suspension, etc.) into a gel (e.g., semi-solid) and/or a solid. Thus, the model forming material may be cured for approximately 5 minutes, 10 minutes, 20 minutes, 30 minutes, 45 minutes, 1 hour, 2 hours, 4 hours, 5 hours, 6 hours, 8 hours, 12 hours or 24 hours, or more than 24 hours. The temperature that each layer is cured at may also be controlled. For example, the model-forming material may be cured for some amount of time at approximately room temperature (e.g., 25° C.), or approximately 30° C., 35° C., 40° C., 50° C., 60° C. The temperature may be limited by preventing it from exceeding a maximum temperature or falling below a minimum temperature. In some variations, the airflow over the model-forming material as it is being cured may also be controlled.

The temperature of the model as it is being formed may be controlled during curing or at any step of the formation of the model (including the entire process). The temperature may be controlled by in appropriate manner, including but not limited to heating (e.g., in an oven), cooling (e.g., by blowing air over it, refrigeration, etc.) or by any combination thereof. In some variations, the thickness or amount of model-forming material, or the rate at which model-forming material is applied, is controlled to help regulate the temperature. For example, thinner layers or smaller amounts (e.g., drops or pellets) of material may be added during formation of the model to regulate the temperature of the model (e.g., by preventing the bulk heating that may result), including during curing. Thus, the amount of material forming each layer may be controlled. The amount of material may be controlled by limiting the absolute amount of model-forming material (e.g., less than about 5 g, 10 g, 15 g, 20 g, 25 g, 30 g, 35 g, 40 g, etc.) or by limiting the thickness of the layer (e.g., less than about 0.5 mm thick, 1 mm thick, 2 mm thick, 5 mm thick, 10 mm thick, etc.) or the level of material applied to the case (e.g., to a position with respect to the teeth, gingiva, etc.).

Other methods can also be used to control the temperature of the model during curing, or at any step. For example, cooling or heating may be used to control the model temperature before any layer is cast. The resin or the hardener (or both) may be heated or cooled before, or during the mixing. For example, the resin and hardener may be cooled or heated separately, during the mixing process, or after mixing. Whether cooling or heating is required may depend upon the application requirements. For example, in forming dental aligners using Epoxy, the Epoxy components (resin and hardener) may be cooled during mixing to maintain a low temperature (e.g., room temperature or lower).

The layers may also be treated before, during or after curing. One or more layers may be treated to improve bonding of the layers to additional layers. For example, the surface of a layer may be laser or chemically etched, scored, or the like. Adhesives may also be used. An adhesive may be added on all or a part of a layer before adding another layer.

In some variations, the model-forming material may include a stabilizer. For example, the model-forming material may include a thermal stabilizer such as Al powder, glass powder (or fibers), or the like. The stabilizer may also be a structural stabilizer (such as a fibrous material). For example, when the model-forming material is Epoxy, the stabilizer may be mixed with the resin before the addition of the hardener.

A casting chamber may also be used during the method of making a dental model. For example, the cast may be placed into a casting chamber, and secured. The casting chamber may closeable, and may include one or more ports for venting, or for the addition of model-forming material. The casting chamber help form the shape of the dental model (e.g., in those region of the dental model that extend beyond the cast, including fiduciary markers such as pins, etc.).

The method of forming a dental model may also include a step of annealing the dental model. Annealing may serve to further harden the dental model, and may be done as a post-processing step. For example, the dental model may be annealed by baking it (e.g., by subjecting the dental model to an elevated temperature). For example, the model may be annealed by exposing the dental model (or the dental model in the casting chamber and/or cast) to about 40° C., 50° C., 60° C., 70° C., 80° C., or 90° C. for greater than about 2 hours (e.g., for about 2 hours, about 3 hours, about 4 hours, about 8 hours, about 12 hours, etc.).

Also described herein are methods of making a dental model including mixing Epoxy for a first layer, applying the first layer of Epoxy to a cast by brushing at least a portion of the Epoxy on at least a portion of the cast and pouring at least a portion of the Epoxy into the cast, curing the first layer of Epoxy, mixing Epoxy for the second layer, applying the second layer of Epoxy, and curing the second layer of Epoxy. A third layer, fourth layer, fifth layer, etc., may be also be applied after mixing the Epoxy for each layer. In some variations, there is at least a 10 minute wait between mixing each layer of Epoxy. The Epoxy may be cured between each layer by waiting an appropriate amount of time, and/or by exposing the cast and model-forming material to an appropriate temperature, as described above. Any appropriate Epoxy may be used, including Epoxy to which stabilizer has been added (e.g., Al powder).

Also described herein are dental models comprising a plurality of solid layers formed from sequentially cured layers of Epoxy, wherein at least one layer includes a stabilizer. Any appropriate stabilizer may be used, including Al powder or fibers, glass powder or fibers, etc.

The details of one or more variations of the invention are set forth in the accompanying drawing and in the description below. Other features, objects, and advantages of the invention will become apparent from the description and drawings, and from the claims.

### BRIEF DESCRIPTION OF THE DRAWINGS

The accompanying drawing, which are incorporated in and form a part of this specification, illustrate embodiments of the invention and, together with the description, serve to explain the principles of the invention:

FIG. 1 illustrates one method of casting a multi-layer dental model, as described herein.

FIG. 2 illustrates a casting chamber for forming a dental model, as described herein.

FIG. 3A is a graph showing the temperature over time of different amounts of Epoxy during curing in an oven.

FIG. 3B is a graph showing the temperature of different amounts of Epoxy during curing in the open air.

FIG. 4 illustrates the formation of a dental model as described herein.

FIG. 5 illustrates another variation of forming a dental model as described herein.

### DESCRIPTION OF INVENTION

The following detailed description should be read with reference to the drawings. The drawings, which are not necessarily to scale, depict selective embodiments and are not intended to limit the scope of the invention. The detailed description illustrates by way of example, not by way of limitation, the principles of the invention.

The methods and devices described herein may be used to create accurate dental models, including models of a subject's dental arches. The model may be generated from a subject's actual dentation or another model, or from records or measurements (direct or indirect) made from the subject's teeth. For example, a model may be reproduced from an impression taken from a subject's mouth, or from a recorded model (e.g., a digital model) recorded from a subject, or from direct measurement taken from a subject. Although many of the examples below describe the creation of a model from a negative impression taken from a subject's mouth, it should be understood that the methods of making dental models described herein are not limited to making dental models from negative impressions.

Before describing the present invention, it is to be understood that unless otherwise indicated, the methods and devices described herein need not be limited to applications for dental models or for orthodontic treatments. As one of ordinary skill in the art having the benefit of this disclosure would appreciate, variations of the invention may be utilized in various other applications, including the formation of other bone models, or models of other body parts. The methods of making dental models described herein may also be modified to support research and/or teaching applications, and are particularly useful anytime accurate and durable models would be helpful. Moreover, it should be understood that variations of the present invention may be applied in combination with various dental diagnostic and treatment devices to improve the condition of a subject's teeth.

As used herein, dental models may include models of one or more teeth, the gums (e.g., gingiva), the roof of the mouth, tongue, or any other portion of the oral cavity in any combination or subset. For example, a dental model may include the upper arch, or the lower arch, or portions of the upper and/or lower arches. It must also be noted that, as used in this specification and the appended claims, the singular forms “a,” “an” and “the” include plural referents unless the context clearly dictates otherwise. Thus, for example, the term “a tooth” is intended to mean a single tooth or a combination of teeth, “an arch” is intended to mean one or more arches (e.g. both upper and lower dental arches). Furthermore, as used herein, “calculating,” and “formulating” may include the process of utilizing manual and/or computer calculations, such as those used to create a numeric representation of an object (e.g. a digital model) or to measure differences in tooth position. For example, a digital representation may comprise a file saved on a computer, wherein the file includes numbers that represent a three-dimensional projection of a tooth arch. In another variation, a digital representation comprises a data set including parameters that can be utilized by a computer program to recreate a digital model of the desired object.

The term “dental aligner” may refer to any dental device for rendering corrective teeth movement or for correcting malocclusion. One or more dental aligners can be worn on the subject's teeth so that a subject wearing the dental aligners will gradually have his or her teeth repositioned by the dental aligner “pushing” (or pulling) against the teeth, or gums (gingiva). As used herein, a “subject” may include any subject (human or animal) whose dental structure (e.g., teeth, gingiva, etc.) may be modeled by the devices, methods, and systems described herein, including orthodontic patients.

Methods of Fabricating Models

In general, the dental model is formed from an imprint taken from the subject's oral cavity (e.g., the upper or lower dental arch). This imprint from which the dental model is formed may be referred to as a cast, or a mold. As described above, the cast may at least partially consist of an imprint (a negative impression) taken directly from a subjects mouth, or it may be made using measurements made from a subject (e.g., by direct measurement or recorded measurement).

For example, a cast can be filled with a model-forming material (also referred to as a casting material), which can be solidified into a physical model of a region of the subject's oral cavity, such as the upper or lower dental arch. Reference marks may be simultaneously molded or included in the dental model, so that the dental model can be coordinated with the subject's actual dental structures (e.g., teeth). The more accurate the model, the better coordination between the model and the subject. In addition to the disclosure described herein, additional detail on the formation of dental models (and particularly dental models that may be used to form aligners for aligning a subject's teeth) can be found in U.S. patent application Ser. No. 11/013,160, titled “System and Methods for Casting Physical Tooth Model” by Huafeng Wen, filed Dec. 14, 2004, and U.S. patent application Ser. No. 10/979,823, titled “Method and Apparatus for Manufacturing and Constructing a Physical Dental Arch Model” by Huafeng Wen, filed Nov. 2, 2004, the disclosures of which are herein incorporated by reference in their entirety.

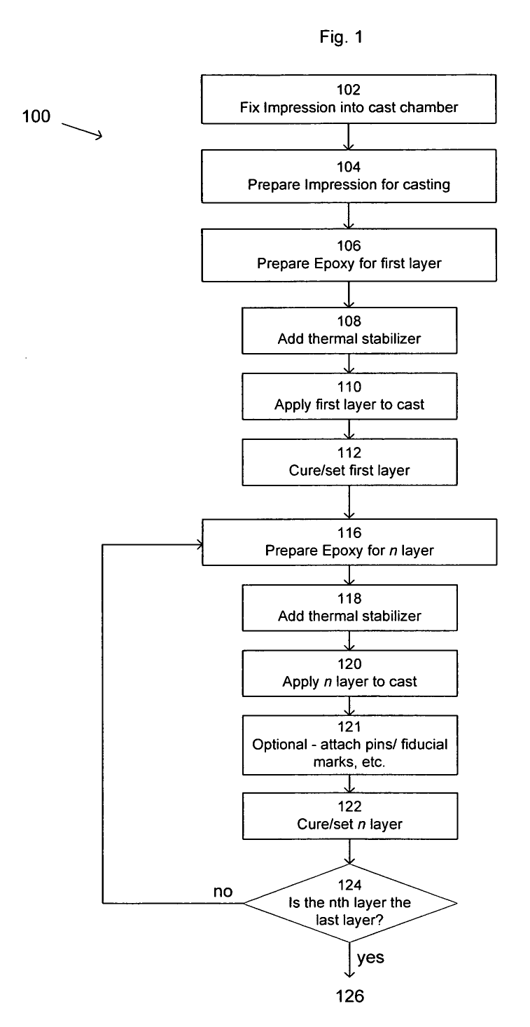

FIG. 1 illustrates one variation of a method of making a dental model 100 as described herein. In this variation of the method for making a dental model, the dental model is formed in a multi-step procedure from a settable material, such as Epoxy, which is sequentially layered into the cast and allowed to set up within the cast. Forming the dental model in sequential layers in this manner may allow the cast to be made without deforming or shrinking, producing a more accurate dental model. For example, the dental model may be formed of Epoxy by serially adding Epoxy material to the cast, and allowing the Epoxy to cure before adding additional Epoxy. After each addition, the Epoxy is allowed to set up and/or cure. The amount of Epoxy added may be small enough that deformation during formation, curing or annealing of the model is minimized. For example, the amount of Epoxy added may also be small enough (or applied in a thin enough layer) so that heat generated by the curing or setting of the Epoxy does not increase the temperature of the model significantly as it is formed. In some variations, a stabilizer (e.g., a thermal stabilizer) may be added to the Epoxy to help stabilize the material as it is added.

In FIG. 1, the impression is first placed in a casting chamber and secured into place 102. In some variations, the casting chamber is not used, however a casting chamber may make it easier to manipulate or handle the cast and dental model as it is being formed. The casting chamber may also provide a stable orientation for the cast or dental model. For example, the casting chamber may help orient fiduciary markers. In some variations, the casting chamber may be used to help shape at least a region of the dental model. For example, the casting chamber may provide a shape to a region of the dental model that does not reflect the subject's oral cavity (e.g., the base region, including the pins).

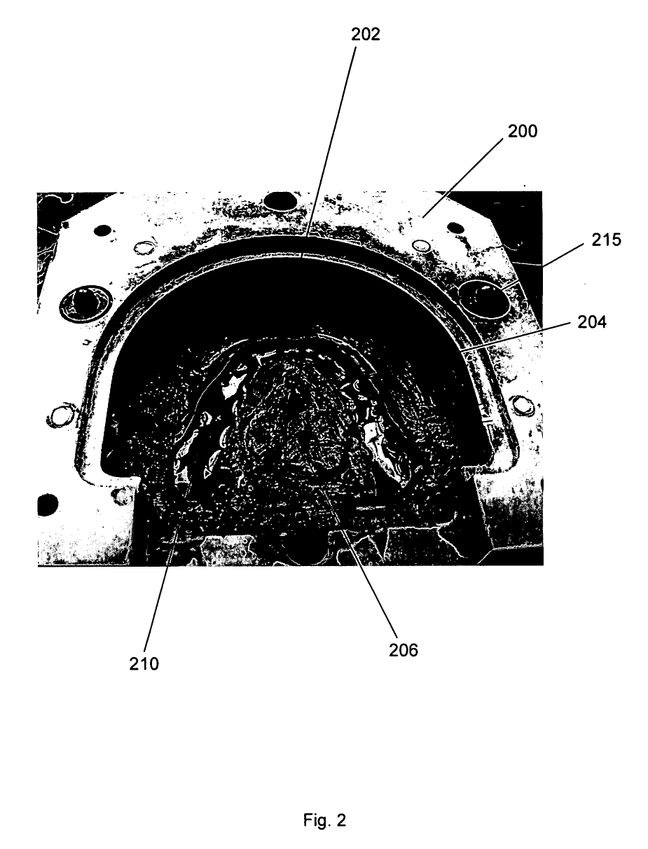

The casting chamber typically includes a cavity into which the cast may be placed. The casting chamber may also include an orientation, so that the cast is oriented within the casting chamber. In some variations, the casting chamber includes at least one holdfast for holding the cast within the cavity. For example, the cast may be held in position by clamps, screws, adhesive, etc. One variation of a casting chamber including a cast is shown in FIG. 2. In FIG. 2, the casting chamber 200 has an opening 202, into which a negative imprint (cast) 204 has been secured by malleable putty 206. In this variation, the putty is the holdfast which acts to secure the cast within the casting chamber.

The casting chamber may be made in any appropriate shape and size, but is preferably large enough to hold casts for a variety of different-sized subjects. U.S. patent application Ser. No. 11/013,160 (filed Dec. 14, 2004), incorporated by reference in its entirety, describes variations of casting chambers which may be used with the devices and methods described herein. Furthermore, the casting chamber may be made of any appropriate material. For example, the casting chamber may be made of a thermally conductive material (e.g., a metal or alloy such as steel, aluminum, etc.). Thermally conductive materials may be particularly helpful for cooling or heating the model during the steps of formation (e.g., during curing, etc). The casting chamber may also include temperature controlling components, such as heating/cooling elements and/or sensors. The casting chamber may also include ports open to atmosphere or for connecting to air or other fluid sources. For example, the casting chamber may include one or more air ports for venting or cooling the material used to form the model. The casting chamber may also include one or more ports for applying model-forming material within the casting chamber.

The casting chamber may also include a cover. In some variations, the casting chamber may include a cover that can secure the top of the casting chamber. The casting chamber may also include handles, grips and/or guides to assist with handling the casting chamber and/or model.

Once the cast is secured within the casting chamber, the cast (and/or the casting chamber) may be prepared for the addition of any model-forming material 104 (e.g., Epoxy or Polyurethane). For example, the cast and/or the casting chamber may be coated with a material (e.g., lubricant, adhesive, hardener, colorant, etc.) before the addition of the model-forming material. In some variations, the cast and/or casting chamber is lubricated so that the model can be more readily removed after it has been formed. In some variations, the cast and/or casting chamber may be coated with a material that will comprise the outer layer of the dental model. Any appropriate material may be used to treat the cast and/or casting chamber. For example, a lubricious material (e.g., an oil-based lubricant, water-based lubricant, or the like) may be used. In some variations, an additional lubricious coating is not needed because the cast is formed from a material that incorporates a lubricant (e.g., polymeric materials such as vinyls, etc.).

A coating or treating material may be applied to the cast and/or casting chamber in any appropriate manner, including spraying, dipping, rinsing, painting, or the like. The cast and casting chamber may also be prepared by controlling the temperature. In some variations, the cast and casting chamber may be prepared by wetting the cast surface. In one variation, a petroleum-based lubricant (e.g., Vaseline™) is applied to the inner surfaces of the casting chamber (excluding the cast). For example, in FIG. 2, the lubricant can be applied to the inside of the casting chamber, the inner part of the cast chamber lid, any spaces between the casting chamber and the putty holding the cast, as well as any spaces between the cast and the putty.

Once the cast and casting chamber have been prepared 104, the model-forming material may be prepared 106. The model-forming material may be any appropriate material or materials for adding to the cast to build the model. In general the model-formning materials is a settable material that can be poured, sprayed, painted, or otherwise applied into the cast and/or casting chamber so that it conforms to the space created by the cast. In some variations, the model-forming material is a flowable material (e.g., a liquid) that sets up or hardens to form a solid after curing. In some variations, the model-forming material includes a granular solid having a small particle size, so that the individual particles may fit within the imprint of the cast. The solids may then be crosslinked or otherwise hardened to form a solid shape. In some variations, the model-forming material is a polymeric material such as polyurethanes (e.g., Dynacast™) or Epoxy.

The model-forming material may also comprise non-polymeric materials, including inorganic materials (e.g., plasters, dental stone, etc.). Inorganic model-forming materials may also be formulated as a liquid, suspension or paste that is applied to the cast and that then hardens into a solid model that can be removed from the cast. Other examples of model-forming materials include metals (such as lead, etc.), plastics (e.g., polymers) and the like.

For example, the model-forming material may be Epoxy such as RenShape™ or RenCast™. The Epoxy may be a two-component Epoxy, comprising a resin and a hardener that can be mixed immediately before use. The mixture of resin and hardener typically forms a viscous liquid material that can be applied to the cast. The model forming material may also include one or more stabilizers to prevent deforming or shrinking of the model as it is formed or hardened.

Returning to FIG. 1, a stabilizer (e.g., a thermal stabilizer) may be added to the model-forming material (exemplified in the figure as Epoxy) 108 before the first layer is applied to the cast. The model-forming material may then be added or applied to the cast to form the first layer of the model 10. The first layer within the cast is then cured, or allowed to at least partially harden 112. In some variations, the first layer of model-forming material is allowed to completely harden or cure before preparing and applying the next layer.

As described above, the model is formed in a multi-step process, allowing the model-forming material to “cure” (at least partially) between the steps. In some variations, the multi-step process includes the forming of two or more layers by the sequential application of the model-forming material within the cast. For example, the first layer can be applied as a thin coating that covers the cast or part of the cast. Shrinkage or other deformation of the model may be avoided by limiting the amount (or thickness) of model-forming material applied to the cast. For example, some model-forming materials may generate heat (especially during curing) that may result in shrinkage or deformation during (or after) formation of the model. The heat generated by the model-forming material may be controlled to prevent such effects.

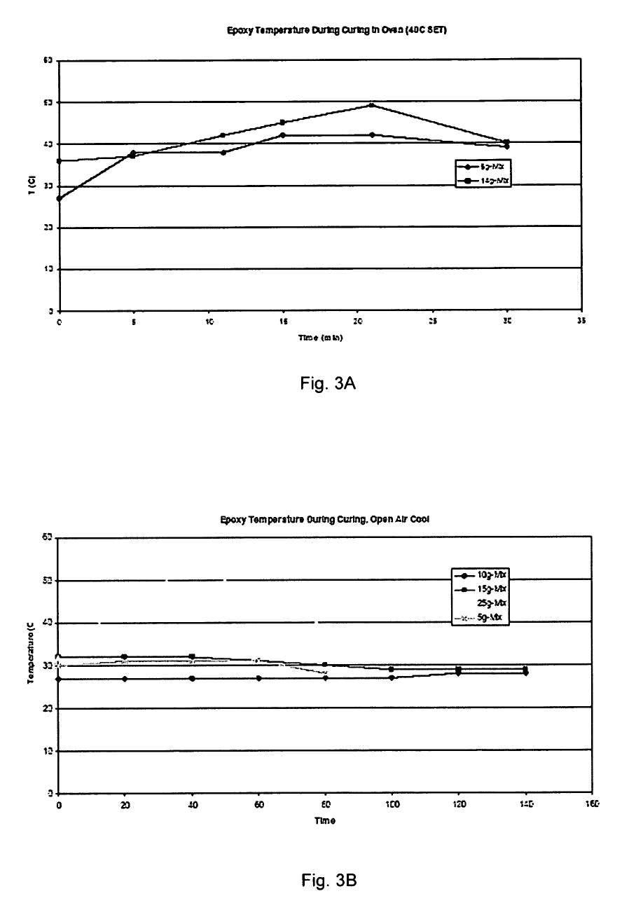

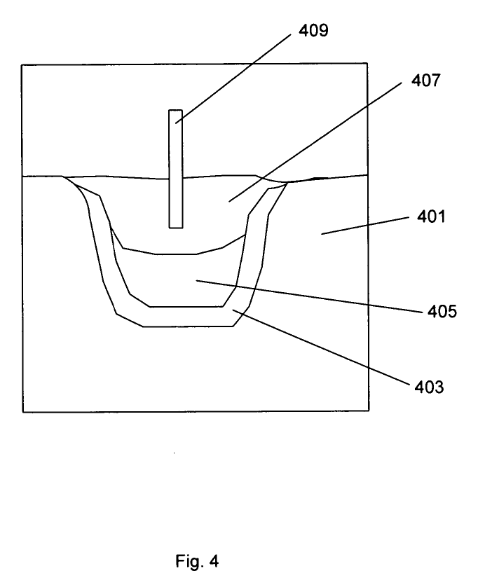

For example, FIGS. 3A and 3B show graphs of the temperature of different amounts or thicknesses of one variation of model-forming material (e.g., Epoxy). In FIG. 3A, various amounts of Epoxy (5 g and 14 g) are cured in an oven set to 40° C. The peak temperature during curing of this Epoxy occurs about 20 min. after mixing. After about 30 min at 40° C., the Epoxy mixture experiences significant hardening. FIG. 3B, shows the temperature taken from different amounts of Epoxy (5 g, 10 g, 15 g, and 25 g) as they are cured in the open air over time. The head generated by the Epoxy during curing is dependent upon the mass of the Epoxy mix. As the mass of the Epoxy mixture increases, the temperature generated by the curing (or the temperature retained by the Epoxy mixture) increases. Thus, to prevent the temperature inside of the impression from going above a given temperature (e.g., 60° C.), the amount of Epoxy applied to the cast can be limited. For example, the total mix weight of the Epoxy added may be kept less than 5 g, 10 g, 15 g, 20 g, 25 g, 30 g, 35 g, etc. The temperature of the model-forming material can be controlled by cooling, heating, or enhancing cooling or heating (e.g., by controlling thickness), at any stage during formation of the model. For example, the model may be cooled during curing by refrigeration or by blowing air on the layer. In some variations, controlling the size or thickness of the layer may help regulate the temperature, as described herein.

Each layer of model-forming material may be added in any appropriate manner. For example, the model-forming layer may be added by pouring an amount (e.g., less than 20 g, less than 15 g, less than 10 g, less than 5 g) of prepared Epoxy into the cast and allowed to cure. In some variations, a layer of model-forming material may be painted on or into the cast. For example, Epoxy may be applied using a paintbrush to coat the cast. A layer of model-forming material may be sprayed into the cast. After addition of the model-forming layer to the cast, the cast (e.g., the entire casting chamber) may be agitated to help remove any bubbles that may have formed during the application of the material to the cast. The cast and model material may then be cured (at any appropriate temperature, including room temperature) for the appropriate amount of time in order for the model-forming material to set up or hardened. In some variations, the model-forming material transitions from a liquid material into a gel, and finally into a solid, over time. The time between the application of each layer may therefore be based upon the time required for the material to transition from the liquid to the gel or solid state. Hardening of the model-forming material may also be material and/or temperature dependent. Thus, the temperature at which each layer is allowed to cure may be controlled.

Any appropriate amount of model-forming material may be added to the cast for each layer. In general, the layers are added to avoid the formation of a large mass of model-forming material that could result in a region of elevated temperature as the mass cures or sets, since heating of the model-forming material might cause expansion and then shrinkage of the model and/or cast. For example, the first layer may comprise less than about 0.5 in³ of material per tooth in the model. However, the average volume of each tooth is approximately 2.5 in³. Thus multiple layers may be added to form the model. In some variations, the model comprises at least three layers. Furthermore, different amounts of material may be added for each layer. The first layer(s) generally include less material than later layers, since the first layer(s) may be closest to the surface of the cast, and therefore it may be important to minimize shrinkage or deformation of these detail-rich surfaces.

As described, different layers may comprise different materials. For example, a layer of adhesive may be used between different layers to help adhere the different layers together. The different layers may also be treated to aid in adhesion of layers to each other or to other components of the model (e.g., pins, labels, etc). For example, the surface of a layer may be treated by etching or scoring (e.g., laser and/or chemical etching).

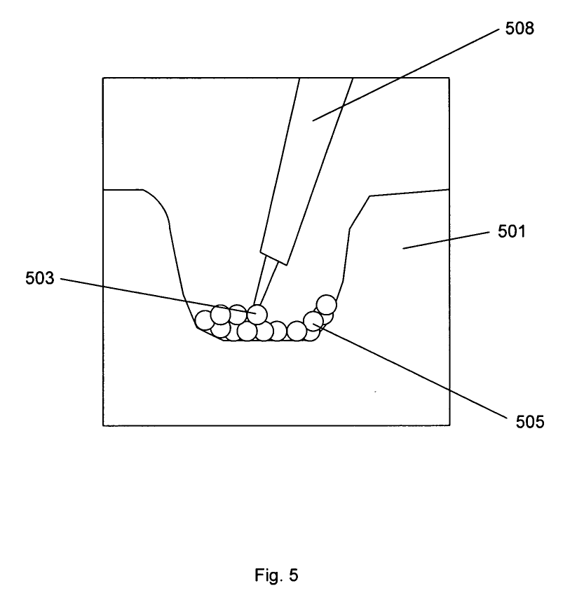

FIG. 4 illustrates the addition of different layers to form a dental model. In FIG. 4, the first layer 403 coats the surface of the cast 401. After applying the first layer, it is at least partly cured, and a second layer 405 is applied. The second layer is then at least partly cured, and a third layer 407 is applied. A pin 409 is shown added to the second layer. Pins may be used so that the model can be attached (and properly oriented) on a base plate. Pins may be pre-coated with model-forming material (e.g., the ends of the pins that insert into the model). In some variations, the pins are added with the last layer of model-forming material. As described above, more than three layers may be applied, and the layers may be added in a different manner. For example, the first layer may be added as a horizontal stratum, rather than as a coating of the cast or previous layer.

In some variations, the later layers (e.g., the last layers added) may be thicker than the previous layers because the layers that have already been applied in the model may prevent deformation of the forming model by the layers added layer. Thus, the initial layers applied to form the model may be continuous or connected layers that (once applied and cured to form part of the model) can provide structure and rigidity to the model as it is being formed. For example, the last layer can be cast with the chamber closed, and can be quite thick (e.g., >5 mm). The heat generated or retained by this layer as it cures may be difficult to control because it is so thick, which may result in distortion of the layer and/or the model. However, as described herein, the layers already applied by the model may prevent possible deformation of this thicker layer from deforming the model as a whole.

After each layer is added, the cast may be agitated (e.g., shaken on a shaker) to remove any air bubbles from the layer. Subsequent layers may be made of the same model-forming material, or they may comprise different model-forming materials, and may be applied by the same method (e.g., pouring, brushing, spraying, etc.), or a different method. Thus, the multi-step process allows different layers to include different materials, or different amounts of the same materials (e.g., hardeners, stabilizers, etc.). Returning to FIG. 1, steps 116-124 can be repeated for each n layer, until all layers (1 to n) have been added. As described above, the model-forming material (e.g., Epoxy) may be prepared fresh for each layer 116, and any stabilizer (e.g., thermal stabilizer) may be included with the model-forming material 118. The material can then be added to the cast to form the next layer 120. Each layer can be at least partially cured for any appropriate amount of time 122. For example, the second, third . . . n layer can be cured for between 10 minutes and 12 hours at room temperature (or at any appropriate temperature, such as 40° C.). Thus, in FIG. 1, steps 116-124 are repeated for each n layer, until all layers (1 to n) have been added 124.

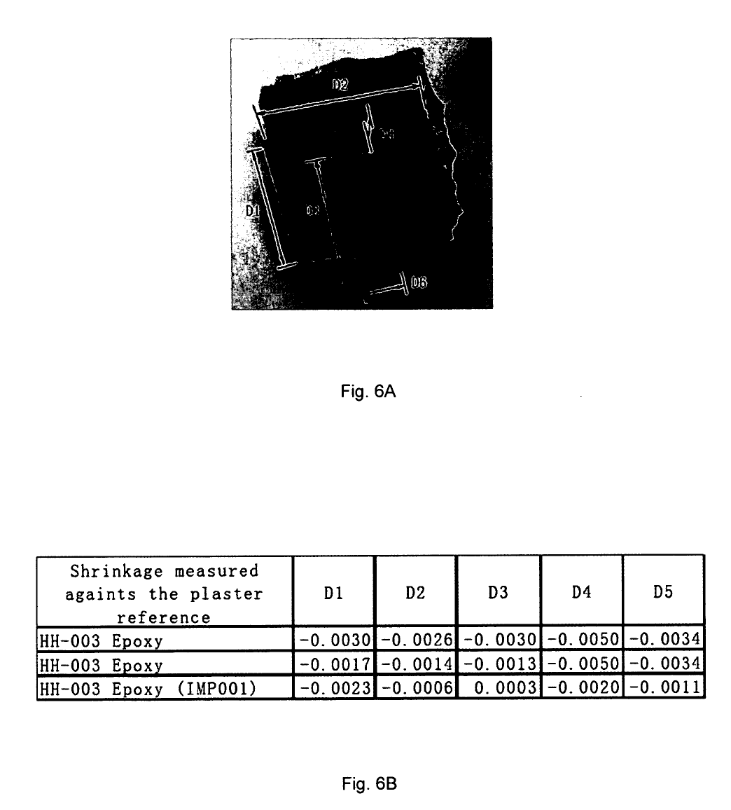

In one variation of the method of making a dental model described herein, model-forming material is added so that it cures and sets up as it is added to the cast. For example, FIG. 5 illustrates one variation of this method. In FIG. 5, a small amount of material 503 is added to form pellets 505 within the cast 501. As the material is applied, it immediately begins curing. Thus, The model-forming material 503 may be premixed and kept from curing by being sealed within an applicator 508. For example, the model forming material may cure only when exposed to air, or at a predetermined temperature. Thus, the material can be applied in small amounts or layers (including layers of pellets, horizontal layers and non-horizontal layers) at least partially cure before adding more model-forming material. Pins or other fiduciary markers may also be added. In some variations, the addition of material is suspended and resumed during formation of the model in order to ensure that the fiduciary markers are properly positioned.

In another variation, the model may be formed with one or more supports, scaffolds or cores. For example, such a framework may be placed within the cast, and the model-forming material can be layered around the framework to from the model. In one variation, a core is formed of a material (including a model-forming material) that is allowed to shrink. Thus, the core may be a first layer of material that is placed in the mold, and then allowed to shrink. Additional layers can then be added around this core as described herein, so that the model fills in or corrects the model shape until it conforms to the cast.

As described above, stabilizers may be included as part of the model-forming material. Stabilizers may be thermal stabilizers, such as Al powder, fiberglass, glass powder, etc. Any appropriate stabilizer may be used. For example, the amount of stabilizer may be added as a weight percent of the total model-forming material. In some variations, the stabilizer comprises about 2%, 5%, 10%, 20%, 25%, 30%, 40%, 50%, 70% of the model-forming material, by weight. The stabilizer may provide regions within the model that are not as affected by the heat- or curing-induced shrinkage of the model-forming material (e.g., Epoxy). The amount of stabilizer used may be maximized while still allowing the model-forming material to retain sufficient structural strength.

FIGS. 6A and 6B illustrate a stabilizer that decreases the shrinkage in a model block of Epoxy. The stabilizer used in this example is Al powder. FIG. 6A shows the model block. This “standard” is first used to make a negative model (cast) from which Epoxy model is made. The entire block is cast from one batch of Epoxy prepared without stabilizer (HH-003 Epoxy 1 and HH-003 Epoxy 2) and with stabilizer (HH-003 Epoxy (IMP001)). All three models were then measured in each of five different dimensions, D1 to D5, as illustrated in FIG. 6A, and these measurements were compared to the actual sizes of each of these dimensions from the original standard block. The data shown in FIG. 6B illustrates that, in general, the block in which stabilizer (IMP001) was included shrunk less than the blocks without stabilizer (HH-003 Epoxy 1 and HH-003 Epoxy 2). The measurements given in the table for the dimensions were obtained by dividing the measured dimension of the Epoxy model from the dimension of the original standard, and subtracting 1.000 (one).

Once the model has been formed as described above, it may be post-processed by undergoing one or more additional steps. For example, the model may be annealed by exposing it to a temperature that strengthens the material. For example, the model may be baked at an elevated temperature (e.g., a temperature or temperatures between 40° C. and 90° C.) for an appropriate annealing time (e.g., 2 to 8 hours).

The methods of forming a dental model described above may allow the fabrication of precise models by preventing shrinkage and deformation, particularly shrinkage or deformation due to thermal effects of the model-forming material. Shrinkage and deformation may result in inaccurate models, because it may change the overall shape of the dental model, and may shift the location and orientation of pins or fiduciary markers on the dental model. Deformation may also damage the cast used to form the model.

As described above, the casting process may be used with pins or any other appropriate fiduciary markers. It may be particularly useful to position pins so that the dental model may result in a coordinated dental arch model, such as a digital dental arch model. An exemplary process for generating a digital tooth arch model is described in detail below. U.S. Provisional Patent Application Ser. No. 60/673,970 (filed Apr. 22, 2005), herein incorporated by reference in its entirety, provides additional examples of dental arch models (and pins) that may be formed by the casting methods and devices described herein.

First, negative impressions of the patient's upper and lower tooth arches, and X-ray images of the teeth, are taken through procedures that are well known to one of ordinary skill in the art. Although the X-ray images are not required for generating the digital model of the tooth arch, X-ray images may be utilized either directly by the simulation program or indirectly by the operator to modify or enhance the digital tooth arch model.

The negative impression of the patient's tooth arch is coupled (e.g., glued, bonded, interlocked, etc.) to a container such as the casting chamber (as described above). A three-dimensional position input device (e.g., MicroScribe®, stylus, etc.) can then be utilized to determine an approximate root position for each of the teeth within the tooth arch. For example, a MicroScribe® can be inserted into the negative impression of a tooth to approximate the root position for that particular tooth. In one variation, the MicroScribe® is inserted into the cavity along the longitudinal orientation of the tooth, and, if necessary, further adjusted to a position that approximates the position of the root of the tooth. A computer is then used to record the position of the MicroScribe®, which corresponds to the approximate root position. In one variation, the placement of the MicroScribe® is controlled by an operator. In another variation, an automated system having optical and/or tactile feedbacks is utilized to position the MicroScribe®.

In addition, the approximated root for each tooth may be defined by one or more positioning/placement of micro-scribes. For example, the micro-scribe may be placed within each tooth cavity to define a proximate position of the root for each of the teeth. In another variation, the micro-scribe is used to define two positions or longitudinal axis, which in combination approximates the position of the root for a tooth. Pin-like objects placed on a positive tooth model may be utilized later to simulate the positions defined by the micro-scribe, which in turn represents the approximate position of the root.

In one example, the MicroScribe® is implemented to define four points within each of the tooth cavity within the negative impression of the tooth arch. The four MicroScribe® defined points are then utilized to define the position for the placement of two pins or an asymmetric peg/interface which can simulate the root of the tooth. In another example, the MicroScribe® is implemented to sample a series of points that represent the profile of each of the tooth cavity within the negative impression. For example, three or more points on the surface of the cavity, which represents a tooth, may be sampled by the MicroScribe® to define an approximate surface profile of the tooth. The approximate surface profile is than used to define and approximate root position. For example, two pin positions may be calculated to fit within the approximate surface profile along the longitudinal axis of the tooth. In one variation, a sectional plan is defined at the base of the tooth based on the MicroScribe® sampling of the negative impress representing the gingival tissue. A pair of pin, with a pre-set distance “d”, is then positioned perpendicular to this sectional plan, and centered within the tooth that is defined by the approximate surface profile defined by the MicroScribe®.

Next, a cover plate (e.g., the lid of the casting chamber) is drilled with holes for holding pins that would correspond to root or pin positions defined by the MicroScribe®. The holes may be drilled with a Computer Numeric Control (CNC) machinery utilizing data collected from the micro-scribe measurements. In one variation, the cover plate and the container (e.g., casting chamber) are manufactured with matching reference markers, such that the coordinate system relied on by the micro-scribe can be properly transposed over to the cover plate. Pins are then inserted into the holes on the cover plate. The cover plate is shaped to fit on top of the casting chamber holding the negative impression of the tooth arch. When the cover plate and the container are properly aligned, the position of the pins should correspond to the approximate root positions defined by the micro-scribe. The model may then be fabricated, as described herein. Once the polymer cures, a positive arch is created within the negative impression, with the pins bonded to the positive arch. The user may then decouple the negative impression from the positive arch, resulting in a positive tooth arch of the patient with a plurality of pins that simulates the root position. Optionally, the positive arch may be scanned (e.g., laser 3D scanning, etc.) to generate a three-dimensional digital representation of the tooth arch, which may be utilized later in this process to align the individual tooth.

In one variation, the pin positions can be utilized to determine the relative positions of the teeth in the patient's tooth arch, since the pin positions were defined by the micro-scribe relative to the negative impression of the patient's tooth arch. In another variation, an optional scan of either the positive tooth arch model or the negative tooth arch impression may be performed to determine the relative positions of the teeth in the tooth arch. The optional scan may also be utilized along with the pin information for determining the relative positions of the teeth within the tooth arch. In yet another variation, the optional scan is utilized alone, without the pin information, to determine the relative positions of the teeth within the tooth arch.

An example of a casting method using a dental arch is described below. As mentioned previously, the methods, devices, and systems described herein are not limited to fabrication of dental models, although they may be particularly well-suited to this purpose.

### EXAMPLE

In the following example, a dental model is fabricated using a two part Epoxy (e.g., RenShape™ Epoxy) as the model-forming material. The Epoxy comprises a resin and a hardener that are kept separate until shortly before mixing and applying to the cast. In this example, a thermal stabilizer (e.g., Aluminum powder) is included, as described above. The majority of the steps are performed at room temperature (e.g., 22° C. ±2° C.) unless otherwise indicated.

The casting chamber is prepared by affixing the cast within the casting chamber and applying sealant and/or lubricant to exposed non-cast surfaces. For example, Vaseline™ petroleum jelly is applied to exposed surfaces of the casting chamber and the inner surfaces of the chamber lid. The cast in this example is held within the casting chamber by putty as shown in FIG. 2, and exposed surfaces of the putty may also be coated with Vaseline™.

Immediately before the Epoxy is used, it must be prepared (mixed). A stabilizer may be added and mixed with the resin before the hardener is added. For example, an appropriate amount of Aluminum powder can be added to the resin and mixed by stirring until the Aluminum power is uniformly distributed in the resin. In one variation, the Epoxy is prepared by mixing 14 g of the Epoxy resin (including the stabilizer) with 3 g of Epoxy hardener (to give a weight ratio of approximately 7:1, resin mix to hardener). The resin and hardener mixture should be mixed well.

The prepared resin can be applied as a first layer to the casting chamber. A brush (e.g., a paint brush) may be used to apply a very thin layer of Epoxy on the cast. Applying with a paint brush may help get rid of air bubbles that might otherwise form on the surface of the cast. The brush should be stroked across the surface to remove any air trapped within or below the Epoxy. A layer of Epoxy can then be added (e.g., by pouring) into the “painted” cast. For example, the Epoxy may be added until it is just at the gingival line (e.g., approximately 1 mm above) within the cast, as shown in FIG. 2. The casting chamber can then be agitated an industrial vibrator at a relatively high frequency for approximately 10 minutes, then placed in an oven set to 40° C. for 90 minutes.

The lid of the casting chamber may also be prepared. For example, a base plate for the dental model (into which the dental model can attach) can be attached to the lid of the casting chamber along with the pins that will be included as part of the dental model. The base plate generally includes holes or slots that mate with the pins. In some variations, the pins are positioned into a base plate, and the base plate is affixed to the lid of the dental model. Alternatively, the inside surface of the lid of the casting chamber may include holes that correspond to the pin holes in the base plate, so that pins can be inserted into the lid of the base plate. Thus, when the lid of the casting chamber is closed, the pins can be inserted into the hardening resin. To prepare the pins, a layer of Epoxy is applied to at least the region of the pins that will be inserted into the dental model and the pins may be releasably secured within the base plate or the lid of the casting chamber. The rest of the lid of the casting chamber may be coated with Vaseline™. A brush can be used to apply Epoxy to the pins. The lid of the base plate (including the coated pins) can then be placed on a vibrator to agitate it for at least 10 minutes. The applied Epoxy is typically cured for approximately four hours at room temperature.

Before applying the second layer of Epoxy to the cast, the casting chamber lid is fastened (e.g., by screwing or otherwise securing) to the casting chamber, and the Epoxy for the second layer is prepared by mixing the resin (plus the stabilizer) with the hardener. For example, 28 g of resin (with hardener already added), may be well mixed with 4 g of hardener (to form a 7:1 weight ratio of resin mix to hardener). As described above, each layer can include less than a predetermined amount of Epoxy in order to avoid generating excessive heat as the Epoxy cures, and damaging the model or the cast. For example, less than about 35 g of resin, less than about 30 g of resin, less than about 25 g of resin, less than about 20 g of resin or less than about 15 g of resin may be added to form each layer. The second layer of resin is applied to the cast by pouring the properly mixed resin into the casting chamber. The casting chamber is then placed on the industrial vibrator and agitated for 10 minutes. In this example, there should be at least a ten minute difference between the mixing of the Epoxy for the second layer and the mixing of the Epoxy for the third layer.

Epoxy for the third layer is then mixed. For example, 28 g of resin (with stabilizer) is mixed with 4 g of hardener (in a 7:1 ratio of resin mix to hardener). The Epoxy is mixed well, and then an appropriate amount of Epoxy is poured into the casting chamber and vibrated on an industrial vibrator for approximately 10 minutes. Putty is then be used to block off the overflow port of the casting chamber, and the cast is allowed to cure for at least 12 hours before removing the (now solid) dental model. As described above, the dental model can then be annealed to further harden the material.

Dental Models

Dental models produced by the methods described herein are typically layered solids formed by layers of model-forming material, where each layer has been individually cured. The layers may be visible, for example, when the model-forming material is different between each successive layer. In some variations each layer (e.g., the first layer, the second layer, etc.) is composed of model-forming materials that have different compositions. For example the ratio of resin and hardener used for the Epoxy may be different, or the amount of any stabilizer may be different. The different proportions of resin and hardener may be detectable, and may also result in different properties (e.g., tensile strength, hardness, etc.) for the different layers, and the overall dental model. In some variations, the different layers of a dental model may be not be visible, but may be detected by analyzing a cross-section through the dental model.

In some variations, the dental models comprising layered solids include one or more stabilizers, as described above. For example, a thermal stabilizer (such as Al powder) may be added to at least one of the layers. Additional materials may also be used as stabilizers, including structural stabilizers. For example, fibrous material may be incorporated into the model-forming material of one or more of the layers (examples of structural stabilizers are synthetic fibers and organic fibers, including glass fibers, cotton fibers, cellulose-based fibers, etc). Fibrous materials may increase the structural strength and/or durability of the dental model. Structural stabilizers may be included in at least the first layer of the dental model to provide external strength when the dental model is used, for example, to form dental aligners.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention.

What is claimed is:

1. A method of making a layered dental model, comprising:
applying a first layer of model-forming material to a cast;
curing the first layer of model-forming material;
applying a second layer of model-forming material; and
curing the second layer of model forming material.

2. The method of claim 1, further comprising:
applying a third layer of model-forming material; and
curing the third layer of model forming material.

3. The method of claim 1, further comprising removing the dental model from the cast.

4. The method of claim 1, wherein the model-forming material comprises Epoxy.

5. The method of claim 1, wherein the step of applying the first layer of model-forming material comprises brushing the model forming material against the cast.

6. The method of claim 1, wherein the step of applying the first layer of model-forming material comprises spraying the model-forming material within the cast.

7. The method of claim 1, wherein the step of applying the first layer of model-forming material comprises pouring the model-forming material within the cast.

8. The method of claim 1, wherein the step of applying the first layer of model-forming material comprises applying the first layer of model-forming material so that the temperature of the first layer of model-forming material does not exceed 40° C. during curing at room temperature.

9. The method of claim 1, further comprises the step of preparing the model-forming material, and wherein the step of preparing the model-forming material comprises:
mixing an Epoxy resin with an Epoxy hardener.

10. The method of claim 9, wherein the step of preparing the model-forming material further comprises mixing the Epoxy resin with a stabilizer.

11. The method of claim 10, wherein the stabilizer comprises Al powder.

12. The method of claim 1, further comprising placing the cast into a casting chamber.

13. The method of claim 1 further comprising annealing the dental model.

14. A method of making a dental model comprising:
mixing Epoxy for a first layer;
applying the first layer of Epoxy to a cast by brushing at least a portion of the Epoxy on at least a portion of the cast and pouring at least a portion of the Epoxy into the cast;
curing the first layer of Epoxy;
mixing Epoxy for the second layer;
applying the second layer of Epoxy; and
curing the second layer of Epoxy.

15. The method of claim 14, further comprising:
mixing Epoxy for the second layer;
applying the third layer of Epoxy; and
curing the third layer of Epoxy.

16. The method of claim 15, wherein the second layer is cured for at least 10 minutes before apply the third layer of Epoxy.

17. The method of claim 14, further comprising annealing the dental model by baking the dental model at greater than about 40° C. for greater than about 2 hours.

18. The method of claim 14, further comprising including Al powder as part of the Epoxy in at least the first layer.

19. A dental model comprising a plurality of solid layers formed from sequentially cured layers of Epoxy, wherein at least one layer includes a stabilizer.

20. The dental model of claim 19, wherein the stabilizer comprises Al powder.
